(19) United States
(12) Patent Application Publication
(10) Pub. No.: US 2015/0205524 A1
(43) Pub. Date: Jul. 23, 2015

(54) DISPLAY CONTROLLING APPARATUS, DISPLAY CONTROLLING SYSTEM, DISPLAY CONTROLLING METHOD AND RECORDING MEDIUM

(71) Applicant: CANON KABUSHIKI KAISHA, Tokyo (JP)

(72) Inventor: Kazuhisa Fuke, Yokohama-shi (JP)

(21) Appl. No.: 14/597,476

(22) Filed: Jan. 15, 2015

(30) Foreign Application Priority Data
Jan. 23, 2014 (JP) 2014-010802

(51) Int. Cl. G06F 3/0489; G06F 3/038; G06F 3/0354

(52) U.S. Cl. CPC G06F 3/04892; G06F 3/03543; G06F 3/038

(57) ABSTRACT

A display controlling apparatus, connected to an input apparatus and a display apparatus, comprises: an acquiring unit of acquiring, from the input apparatus, image information of a first image displayed on a display screen of the input apparatus and cursor information indicating a display position of a first cursor image on the display screen; a deciding unit of deciding a display position of a second cursor image in a display range within which the display apparatus displays an image, based on the cursor information acquired by the acquiring unit; and a controlling unit of performing control to display a second image based on the acquired image information and the second cursor image on the display apparatus, and change, according to a change of a size of the second image to be displayed on the display apparatus, a size of the second cursor image to be displayed on the display apparatus.

### BACKGROUND OF THE INVENTION

1. Field of the Invention

The present invention relates to a display controlling apparatus which performs control to display an input image input by an input apparatus and a cursor image generated based on cursor information input from the input apparatus, on a display apparatus.

2. Description of the Related Art

On a computer (e.g., PC (personal computer)) screen, a cursor for indicating positions and instructions based on operations of a device such as a mouse or the like is displayed generally. Recently, also in a certain product such as a television, a projector or the like, a function to display a cursor for the purpose of assisting a user is provided on a graphics screen such as a menu or the like.

Incidentally, a next display position of a cursor on a PC screen is decided on the basis of a remote control code and a mouse movement quantity which are respectively input to a PC by user's operations of devices such as a remote controller, a mouse and the like, and a position on the PC screen at which the cursor is currently displayed.

In the projector, there is a technique of synthesizing a plurality of PC screens and displaying them on the projector screen (hereinafter, called screen transfer). In the screen transfer, when the cursor of each PC connected to the projector is operated, the corresponding cursor displayed by the projector is moved.

As for the cursor display in the screen transfer, there is a case where the PC screens respectively including the cursors are synthesized and displayed together. However, there is a problem in this case that a delay occurs between a time when a cursor operation is actually performed and a time when the content of the cursor operation is reflected in the screen content projected by the projector. To deal with this problem, there is a method by which the PC transmits the movement quantity of the cursor to the projector and thus the projector moves the cursor to be projected on the plane of projection in accordance with the relevant movement quantity.

In the case where the PC transmits the movement quantity of the cursor to the projector, it is necessary to limit the movement area of the cursor to be displayed by the projector and change the image size of the cursor to be displayed, in conformity with the size of the PC screen. Here, as a method of limiting such a cursor movement area, a technique has been proposed in Japanese Patent Application Laid-Open No. H11-194870. This technique enables to limit the movement area of a cursor by dividing a screen into a plurality of areas, and inhibiting the relevant cursor from being moved to the outside of the predetermined area based on the attribute associated with the relevant cursor.

However, in the conventional method as described above, there is a problem that it is impossible to change the image size of the cursor. For example, a case where a user performs an operation to change a state that a projector is projecting an image received from a first device on a plane of projection to a state that the projector together projects the image received from the first device and an image received from a second device on the relevant plane of projection will be described.

In the above case, the size of the image received from the first device on the plane of projection is reduced by a user operation. However, even in this case, since the size of a cursor projected on the plane of projection by the projector is not changed, there is a case where the image received from the first device and the cursor are projected on the plane of projection in a state that the size of the image and the size of the cursor do not conform to each other.

Therefore, there is a possibility that it is hard for a user to view the images projected by the projector.

### SUMMARY OF THE INVENTION

The present invention aims to provide a display controlling system which performs a cursor display in a state that a user can easily view displayed contents even if an image to be displayed is changed.

The display controlling system according to the present invention includes a display controlling apparatus which is connected to an input apparatus and a display apparatus, and which comprises: an acquiring unit configured to acquire, from the input apparatus, image information of a first image displayed on a display screen of the input apparatus and cursor information indicating a display position of a first cursor image on the display screen of the input apparatus; a deciding unit configured to decide a display position of a second cursor image in a display range within which the display apparatus displays an image, based on the cursor information acquired by the acquiring unit; and a controlling unit configured to perform control to display a second image based on the acquired image information and the second cursor image on the display apparatus, and change, according to a change of a size of the second image to be displayed on the display apparatus, a size of the second cursor image to be displayed on the display apparatus.

Further features of the present invention will become apparent from the following description of exemplary embodiments with reference to the attached drawings.

### BRIEF DESCRIPTION OF THE DRAWINGS

FIG. 1 is a block diagram illustrating a configurational example of a cursor controlling system according to embodiments of the present invention.

FIG. 2 is a diagram illustrating an example of a window generation request generated by an application in a first embodiment.

FIG. 3 is a diagram illustrating a window area generated on the whole of a display screen in the first embodiment.

FIG. 4 is a diagram illustrating an example of window management information in the first embodiment.

FIG. 5 is a diagram illustrating an example of a window list in the first embodiment.

FIG. 6 is a diagram illustrating an example of a device generation request in the first embodiment.

FIG. 7 is a diagram illustrating an example of device management information in the first embodiment.

FIG. 8 is a diagram illustrating an example of a device list in the first embodiment.

FIG. 9 is a diagram illustrating an example of a cursor generation request in the first embodiment.

FIG. 10 is a diagram illustrating a cursor area generated on the whole of the display screen in the first embodiment.

FIG. 11 is a diagram illustrating an example of cursor management information in the first embodiment.

FIG. 12 is a diagram illustrating an example of a cursor list in the first embodiment.

FIG. 13 is a diagram illustrating an example of a cursor-device association request in the first embodiment.

FIG. 14 is a diagram illustrating an example of a cursor-window association request in the first embodiment.

FIG. 15 is a diagram illustrating an example of a window position change request in the first embodiment.

FIG. 16 is a diagram illustrating an example of a window size change request in the first embodiment.

FIG. 17 is a diagram illustrating an example of a cursor identifier acquisition request in the first embodiment.

FIG. 18 is a diagram illustrating an example of a cursor display position change request in the first embodiment.

FIG. 19 is a flow chart for describing an example of the overall process to be performed by the application in the first embodiment.

FIG. 20 is a flow chart for describing an example of the overall process to be performed by the device driver in the first embodiment.

FIG. 21 is a flow chart for describing an example of the process of associating the cursor and the window with each other in the first embodiment.

FIG. 22 is a diagram illustrating the area of the window and the position of the cursor which are associated with each other on the whole of the display screen in the first embodiment.

FIG. 23 is a flow chart for describing an example of the process of generating a Z order value of the associated cursor in the first embodiment.

FIG. 24 is a flow chart for describing an example of the process of associating the cursor and the device with each other in the first embodiment.

FIG. 25 is a flow chart for describing an example of the process of updating the cursor display position by the event of the device in the first embodiment.

FIG. 26 is a flow chart for describing an example of the process of changing the cursor size and the display position, according to a change of the window size in the first embodiment.

FIG. 27 is a flow chart for describing an example of the process of changing the cursor display position according to a change of the window position in the first embodiment.

FIGS. 28A, 28B, 28C and 28D are diagrams illustrating the areas of the windows and the cursors on the whole of the display screen, according to changes of the window positions and changes of the window sizes in a window system.

FIGS. 29A and 29B are diagrams illustrating an example of a display screen state at the time of PC screen transfer in the first embodiment.

### DESCRIPTION OF THE EMBODIMENTS

### First Embodiment

Hereinafter, the first embodiment of the present invention will be described with reference to the attached drawings and flow charts.

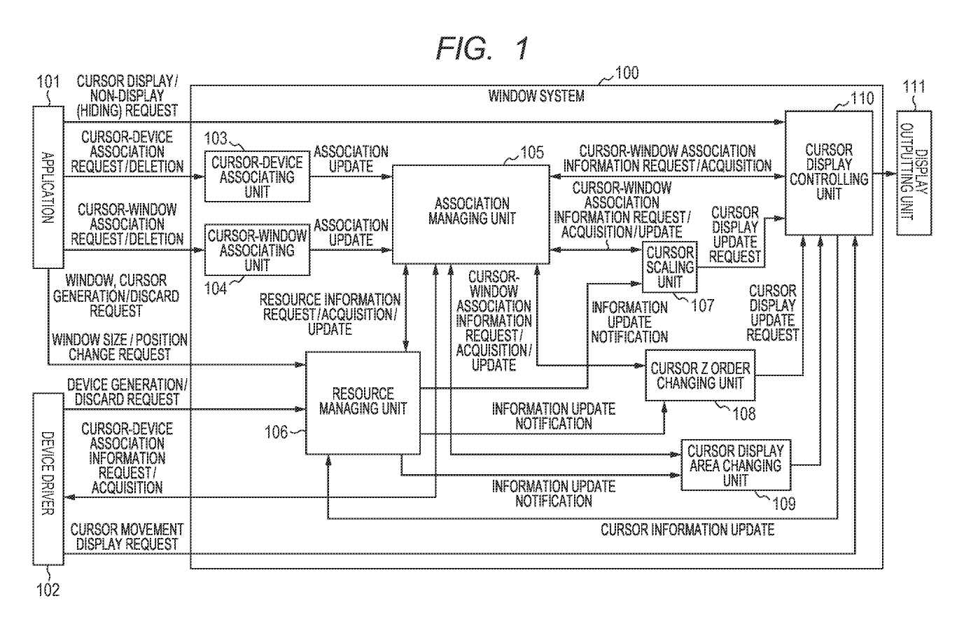

FIG. 1 is a block diagram illustrating a configuration of a window system (a display controlling system) according to the present embodiment.

In the present embodiment, a window system 100 manages resources such as a window, a cursor, a device and the like, superposes the window and the cursor, and outputs them to a display outputting unit 111, according to request instructions from an application 101 and a device driver 102. Here, the plurality of applications 101 and the plurality of device drivers 102 operate simultaneously.

For example, the window system 100 in the present embodiment is connected to a plurality of PCs (personal computers), and acquires an image displayed on the displaying unit of the PC serving as an input apparatus from the PC. Further, the window system 100 acquires information (hereinafter, called cursor information) related to cursor operations on the PC from the PC. The window system 100 may acquire an image and cursor information from an input apparatus other than the PC. Here, the cursor information is the information indicating a movement quantity and a movement direction of a cursor image on the displaying unit of the PC.

The window system 100 in the present embodiment controls a projector serving as a display apparatus to project the image displayed on the displaying unit of the PC and the state that the cursor moves on the displayed image on a plane of projection.

When projecting the image acquired from the PC from the projector onto the plane of projection, the window system 100 can change the size of the image to be projected. Further, the window system 100 generates the cursor image based on the cursor information acquired from the PC. Then, the window system 100 controls the projector to project the generated cursor image on the plane of projection.

The window system 100 in the present embodiment can change the projection size of the image acquired from the PC on the plane of projection, according to a user instruction. The window system 100 in the present embodiment also changes the size of the cursor image to be projected on the plane of projection, according to the change of the projection size of the image acquired from the PC on the plane of projection.

Here, the case where the projection size of the image acquired from the PC on the plane of projection is changed according to the user instruction includes the following case. For example, the case where the window system 100 is connected to a first PC and a second PC will be described.

A user instructs to change the state from a state (one-screen display) that the projector projects the image received from the first PC on the plane of projection to a state (two-screen display) that the projector together projects the image received from the first PC and the image received from the second PC on the one plane of projection.

In this case, the size of the image received from the first PC on the plane of projection is reduced according to an instruction to switch the state from the one-screen display to the two-screen display. The window system 100 in the present embodiment performs control such that the display of the cursor image projected by the projector is reduced in size according to the instruction to switch the state from the one-screen display to the two-screen display. Therefore, the user can browse the projected image without an uncomfortable feeling.

In such an example as described above, the window system 100 controls the projector. However, the present invention is not limited to this. That is, in the window system, it is possible to control the display apparatus instead of the projector to display the image acquired from the PC and the cursor image generated by the window system 100.

The window system 100 in the present embodiment is, for example, a display controlling apparatus which is connected to the input apparatus (e.g., the PC) and the display apparatus (e.g., the projector).

The window system 100 comprises an acquiring unit which acquires, from the input apparatus, image information of a first image displayed on the display screen of the input apparatus and cursor information indicating the display position of a first cursor image on the display screen of the input apparatus. For example, a cursor display controlling unit 110 serving as the acquiring unit acquires the information related to the position and the movement quantity of the cursor from the device driver 102, as a cursor movement display request.

Further, the window system 100 comprises a deciding unit which decides the display position of a second cursor image in a display range (e.g., the plane of projection on which the projector projects an image) within which the display apparatus displays an image, based on the cursor information acquired by the acquiring unit.

Furthermore, the window system 100 comprises a controlling unit which performs control to display a second image based on the acquired image information and the second cursor image on the display apparatus.

For example, the cursor display controlling unit 110 serving as the deciding unit and the controlling unit decides the display position of the cursor image in the display range within which the projector projects the image, and outputs the display instruction of the cursor image to the projector through the display outputting unit 111.

The controlling unit performs control to change, according to a change of the size of the image to be displayed on the display apparatus, the size of the second cursor image to be displayed on the display apparatus.

The window system 100 in the present embodiment acquires, from the PC, the image information related to the image (the first image) displayed on the display unit of the PC and not including the cursor image. In other words, the window system 100 in the present embodiment discriminates, from each other, the first image and the cursor image displayed on the PC screen, and acquires only the first image from the PC. The window system 100 does not directly acquire the cursor image from the PC, but acquires the cursor information indicating the position and the movement quantity on the display unit of the PC. Then, the window system 100 generates the cursor image based on the cursor information in the window system 100, and causes the projector to project the generated cursor image.

Thus, as compared with the case of acquiring the image including the cursor image from the PC and causing the projector to project the acquired image, it is possible to shorten time (i.e., a period) between the time when the cursor operation is actually performed in the PC and the time when the cursor operation is reflected in the screen content projected by the projector.

The controlling unit in the present embodiment performs control to display a third image corresponding to image information input from the first PC in the display range (i.e., the plane of projection) of the projector. Here, a first state that only the third image is displayed in the display range is called the one-screen display. Further, the controlling unit in the present embodiment performs control to display, in addition to the third image, a fourth image corresponding to image information input from the second PC in the display range. Here, a second state that the third image and the fourth image are together displayed in the display range of the projector by such control as above is called the two-screen display.

The size of the third image which is displayed while the two-screen display is being performed is smaller than the size of the third image which is displayed while the one-screen display is being performed.

The controlling unit in the present embodiment performs control to the projector to switch the display from the one-screen display to the two-screen display, and further performs control to change the size of the second cursor image according to the switch from the one-screen display to the two-screen display.

Thus, in proportion to reduction of the size of the third image, it is possible to reduce the size of the cursor image related to the third image. Here, the cursor image related to the third image is the image of the cursor of which the position and the movement quantity are decided by the operation of the pointing device such as the mouse or the like in the first PC through which the image information of the third image is input.

Likewise, if the state is switched from a state that the two-screen display of the third and fourth images is performed to a state that the one-screen display of the third image is performed, the display area of the third image is enlarged. The window system 100 in the present embodiment can also enlarge the size of the cursor image related to the third image in proportion to the enlargement of the display area of the third image.

Thus, the user can browse the projected image and the cursor image without an uncomfortable feeling.

Hereinafter, the constitution of each of the units in the window system 100 will be described with reference to FIG. 1.

To display the PC screen and the cursor, the application 101 generates a window generation request and a cursor generation request for displaying the PC screen and a cursor display request for displaying the cursor, and transfers the generated requests to the window system 100. Further, to perform association, the application generates request instructions such as a cursor-window association request for associating the cursor and the window with each other, a cursor-device association request for associating the cursor and the device with each other, and the like, and transfers the generated request instructions to the window system 100. In addition, the application 101 generates a request for changing the window size and a request instruction for changing the window position, and transfers them to the window system 100.

To perform a cursor movement display in the events by the network and the device such as the mouse or the like, the device driver 102 generates request instructions such as a device generation request, a cursor movement display request and the like, and transfers the generated request instructions to the window system 100. In addition, the device driver generates a cursor-device association information request instruction for acquiring the cursor associated with the device, and transfers the generated instruction to the window system 100.

The window system 100 comprises a resource managing unit 106, a cursor-device associating unit 103 and a cursor-window associating unit 104 which are related to the associations, and an association managing unit 105. In addition, the window system comprises a cursor scaling unit 107, a cursor Z order changing unit 108, a cursor display area changing unit 109 and a cursor display controlling unit 110 which are related to a cursor display update.

The resource managing unit 106 manages resource information according to generation, deletion and information update of the window, the cursor, the device and the like, and returns the identifiers for identifying the respective resources in response to the generation requests from the application 101 and the device driver 102. Further, the resource managing unit updates necessary information in response to resource information update notifications from the association managing unit 105 and the cursor display controlling unit 110. When the resource information is updated, the resource managing unit notifies the information update to the cursor scaling unit 107, the cursor Z order changing unit 108 and the cursor display area changing unit 109.

The cursor-device associating unit 103 provides the function to associate the cursor and the device with each other to the application 101, performs the association of the cursor and the device designated, deletes the association, and requests the update of association to the association managing unit 105.

The cursor-window associating unit 104 provides the function to associate the cursor and the window with each other to the application 101, performs the association of the designated cursor and window and deletion of the association, and requests update of association to the association managing unit 105.

The association managing unit 105 manages the information associated by the cursor-device associating unit 103 and the cursor-window associating unit 104. The association managing unit performs the information update while exchanging necessary information with the resource managing unit 106. The association information to be managed is requested from the device driver 102. Further, the association information is requested from the cursor scaling unit 107, the cursor Z order changing unit 108, the cursor display area changing unit 109 and the cursor display controlling unit 110.

If an information update notification is received from the resource managing unit 106, the cursor scaling unit 107 acquires the cursor association information from the association managing unit 105. If it is necessary from the cursor association information to change the cursor size due to a change of the window size or the like, the cursor scaling unit calculates the size of the cursor, performs scaling, and then requests the cursor display update to the cursor display controlling unit 110.

If the information update notification is received from the resource managing unit 106, the cursor Z order changing unit 108 acquires the cursor association information from the association managing unit 105. If it is necessary from the cursor association information to change cursor Z order due to generation of the window, a change of the Z order or the like, the cursor Z order changing unit updates the cursor Z order, and then requests the cursor display update to the cursor display controlling unit 110.

If the information update notification is received from the resource managing unit 106, the cursor display area changing unit 109 acquires the cursor association information from the association managing unit 105. If it is necessary from the cursor association information to change a cursor display area due to a change of the window size or the like, the cursor display area changing unit updates the cursor display area, and then requests the cursor display update to the cursor display controlling unit 110.

The cursor display controlling unit 110 receives a cursor display/non-display (hiding) from the application 101, receives the cursor movement display from the device driver 102, acquires the cursor association information from the association managing unit 105, and updates the cursor display. Likewise, the cursor display controlling unit updates the cursor display based on the cursor display update from the cursor scaling unit 107, the cursor Z order changing unit 108 or the cursor display area changing unit 109. After the cursor display update, the cursor display controlling unit notifies a new cursor display position to the resource managing unit 106, and outputs the display result on which the window and the cursor are superposed to the display outputting unit 111.

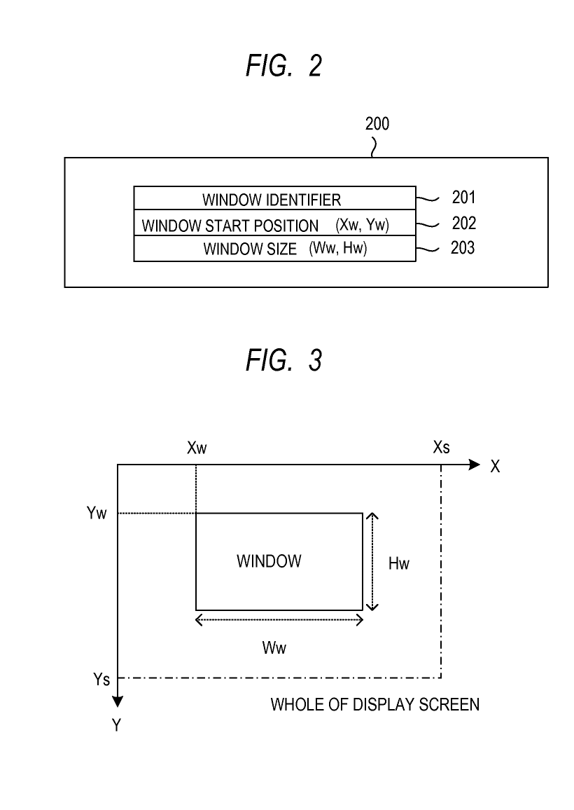

FIG. 2 is a diagram illustrating an example of the window generation request generated by the application 101. In FIG. 2, the whole of a window generation request 200 includes an area 201 which is used to transfer a generated window identifier from the resource managing unit 106 to the application 101, a window start position 202 at which the start position of the window to be generated is designated by (X coordinate, Y coordinate), and a window size 203 by which the size of the window to be generated is designated by a rectangular area of (width, height). Each of the window start position 202 and the window size 203 is the area which is used to transfer the set value from the application 101 to the resource managing unit 106.

FIG. 3 is a diagram illustrating the window area on the whole of the display screen. In response to the window generation request 200, the resource managing unit 106 generates the window from (Xw, Yw) designated by the window start position 202 to (Ww, Hw) designated by the window size 203 from the application 101. After the window is generated, the resource managing unit 106 returns the generated identifier by the window identifier (area) 201 to the application 101.

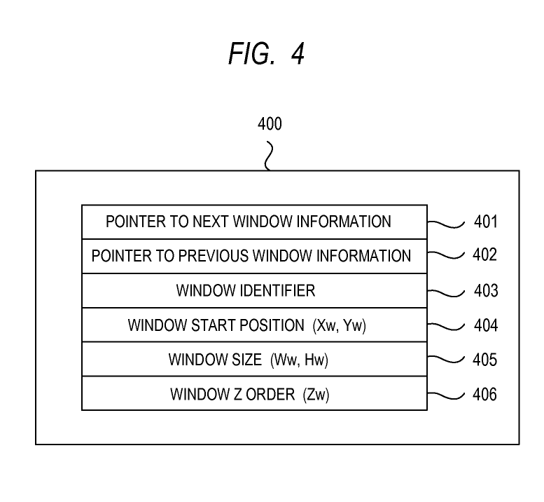

FIG. 4 is a diagram illustrating an example of the window management information to be managed by the resource managing unit 106. Here, the whole of window management information 400, which exists by one in one window, includes a pointer 401 to the window management information to be displayed next to (front) the current window (i.e., the front side), a pointer 402 to the window management information to be displayed previous to (rear) the current window, and a window identifier 403 of the current window. The window identifier has the value which is transferred from the resource managing unit 106 to the application 101 when the window is generated by the window generation request 200.

The whole of the window management information further includes a window start position 404 indicated by (X coordinate, Y coordinate), and a window size 405 indicated by (width, height). Here, each of the window start position 404 and the window size 405 is the value designated from the application 101 when the window is generated by the window generation request 200. The whole of the window management information further includes window Z order 406 which means the hierarchical value in the depth direction of the window. As the window Z order, a unique value is set by considering all the generated windows in the resource managing unit 106, when the window is generated or the Z order of the window is changed.

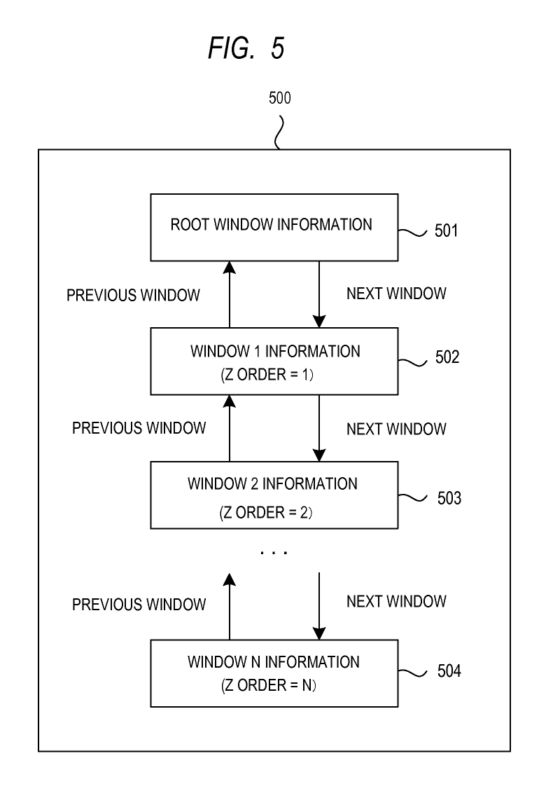

FIG. 5 is a diagram illustrating an example of a window list of the generated windows to be managed by the resource managing unit 106. Here, a whole window list 500 includes root window information 501 which indicates the root window which is the special window generated by the window system 100, and window information 502, 503 and 504 each generated by the application 101.

More specifically, the window information 502 indicates a window 1, and the Z order thereof is 1. The window information 503 indicates a window 2, and the Z order thereof is 2. The window information 504 indicates a window N, and the Z order thereof is N. Here, it should be noted that the Z order having the smaller value is displayed on a deeper side, and that the Z order having the larger value is displayed on a more front size. In the window list, the windows beginning from the root window are link-listed in the order of lower Z order.

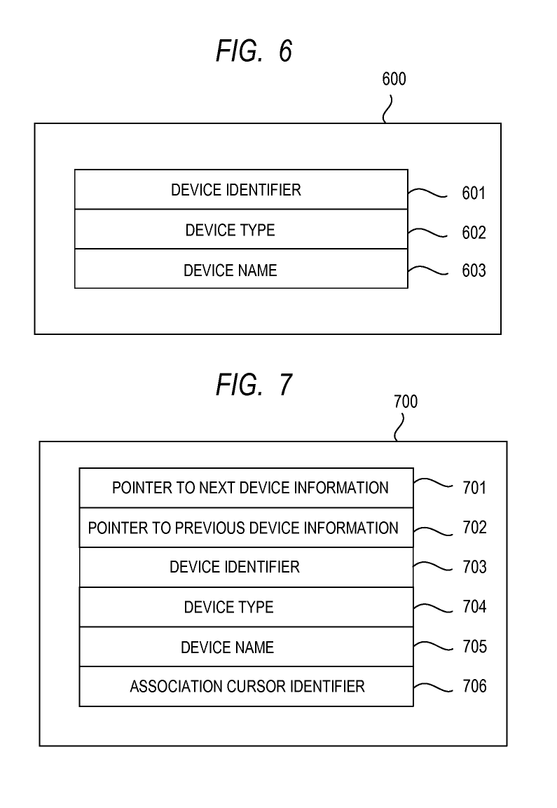

FIG. 6 is a diagram illustrating an example of the device generation request generated by the device driver 102. Here, the whole of a device generation request 600 includes an area 601 which is used to transfer a generated device identifier from the resource managing unit 106 to the device driver 102, a device type 602 for designating a type (kind) of the device to be generated, and a device name 603 for designating a name of the device to be generated. Incidentally, each of the device type 602 and the device name 603 is the area which is used to transfer the set value from the device driver 102 to the resource managing unit 106.

FIG. 7 is a diagram illustrating an example of device management information to be managed by the resource managing unit 106 and the association managing unit 105.

Here, the whole of device management information 700, which exists by one in one window, includes a pointer 701 to the device management information to be displayed next to the current device, a pointer 702 to the device management information to be displayed previous to the current device, and a device identifier 703 of the current device. The value of the device identifier is transferred from the resource managing unit 106 to the device driver 102 when the device is generated by the device generation request 600.

The whole of the device management information further includes a device type 704, and a device name 705. Incidentally, each of the device type 704 and the device name 705 is the value which is designated by the device driver 102 when the window is generated by the device generation request 600. The whole of the device management information further includes an association cursor identifier 706 which is associated with the current device. The association cursor identifier 706 is set by the cursor-device associating unit 103, and used for the management by the association managing unit 105. The association cursor identifier 706 is not used in the resource managing unit 106.

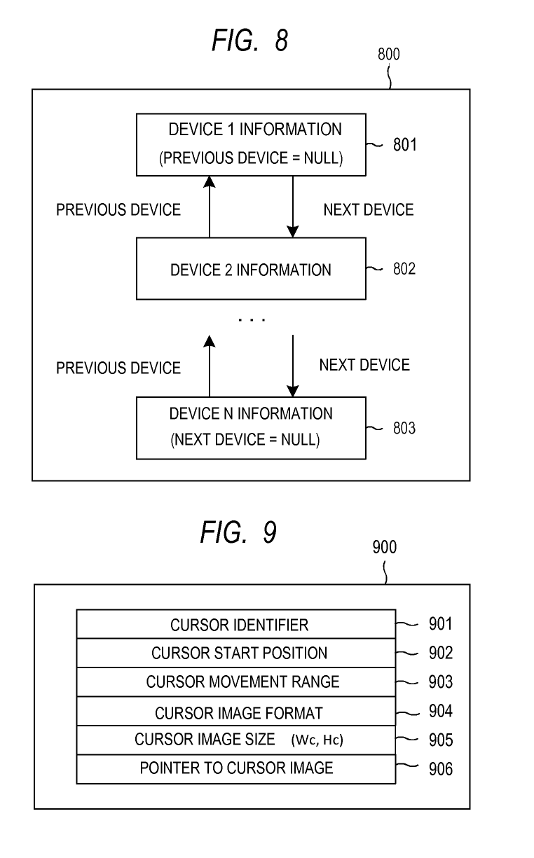

FIG. 8 is a diagram illustrating an example of a device list of the generated devices to be managed by the resource managing unit 106. Here, the whole of a device list 800 includes information 801 indicating a device 1 which is first generated by the device driver 102.

The whole of the device list further includes information 802 and 803 indicating devices generated by the device driver 102. More specifically, the information 802 indicates a device 2, and the information 803 indicates a device N. In the device list, the devices generated from the device driver 102 are simply link-listed in order.

FIG. 9 is a diagram illustrating an example of a cursor generation request generated by the application 101. The whole of a cursor generation request 900 includes a cursor identifier 901 which is the area to be used to transfer the set value from the resource managing unit 106 to the application 101, a cursor start position 902 by which the start position of the cursor to be generated is designated by (X coordinate, Y coordinate), and a cursor movement range 903 by which the movement range of the cursor to be generated is designated by a rectangular area of (X coordinate, Y coordinate, width, height).

The cursor generation request further includes a cursor image format 904 of the cursor to be generated, a cursor image size 905 by which the cursor image size is designated by a rectangular area of (width, height), and a pointer 906 to the cursor image by which the pointer to the actual cursor image is designated. Incidentally, each of the cursor start position 902, the cursor movement range 903, the cursor image format 904, the cursor image size 905 and the pointer 906 is the area which is used to transfer the set value from the application 101 to the resource managing unit 106.

FIG. 10 is a diagram illustrating a cursor area on the whole of the display screen.

In response to the cursor generation request 900 from the application 101, the cursor having the size (Wx, Hc) designated by the cursor image size 905 is arranged at the position (Xc, Yx) designated by the cursor start position 902.

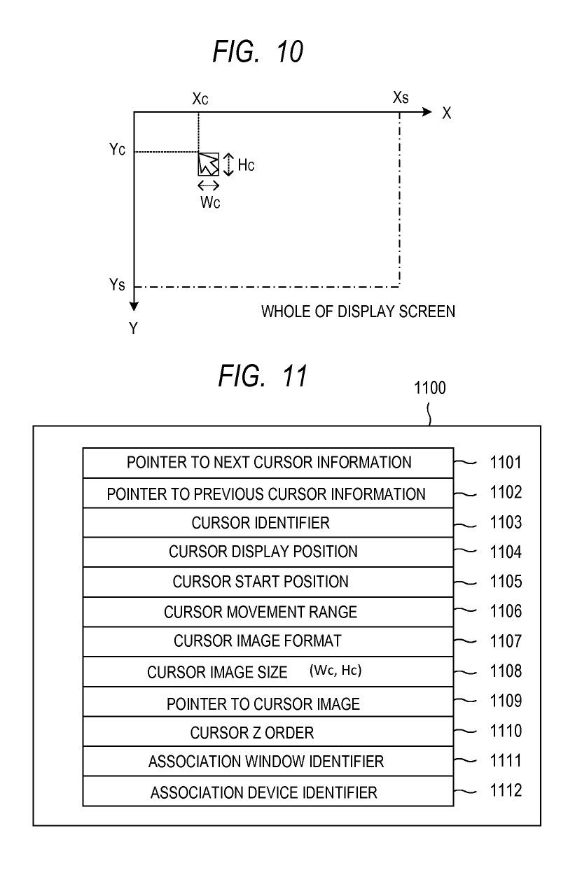

FIG. 11 is a diagram illustrating an example of cursor management information to be managed by the resource managing unit 106. In FIG. 11, the whole of cursor management information 1100, which exists by one in one window, includes a pointer 1101 to the cursor management information generated next to the current cursor, and a pointer 1102 to the cursor management information generated previous to the current cursor.

The whole of the cursor management information further includes a cursor identifier 1103 of the current cursor. The cursor identifier is the value which is transferred from the resource managing unit 106 to the application 101 when the cursor is generated by the cursor generation request 900. The whole of the cursor management information further includes a cursor display position 1104 indicated by (X coordinate, Y coordinate), a cursor start position 1105 indicated by (X coordinate, Y coordinate), and a cursor movement range 1106 indicated by (X coordinate, Y coordinate, width, height).

The whole of the cursor management information further includes a cursor image format 1107, a cursor image size 1108 indicated by (width, height), and a pointer 1109 to the cursor image. Here, each of the cursor start position 1105 to the pointer 1109 is the value which is designated from the application 101 when the cursor is generated by the cursor generation request 900.

The whole of the cursor management information further includes cursor Z order 1110 which means the hierarchical value in the depth direction of the cursor. As the cursor Z order 1110, a unique value is set by considering the Z order value of the associated window with the cursor Z order changing unit 108 when the cursor is generated, the associated window is generated, or the Z order is changed. The whole of the cursor management information further includes an association window identifier 111 which is associated with the current cursor, and an association device identifier 1112 which is associated with the current cursor. Here, the association window identifier 1111 and the association device identifier 1112 are respectively set by the cursor-window associating unit 104 and the cursor-device associating unit 103, and these identifiers are used for the management of the association managing unit 105. The association window identifier 1111 and the association device identifier 1112 are not used in the resource managing unit 106.

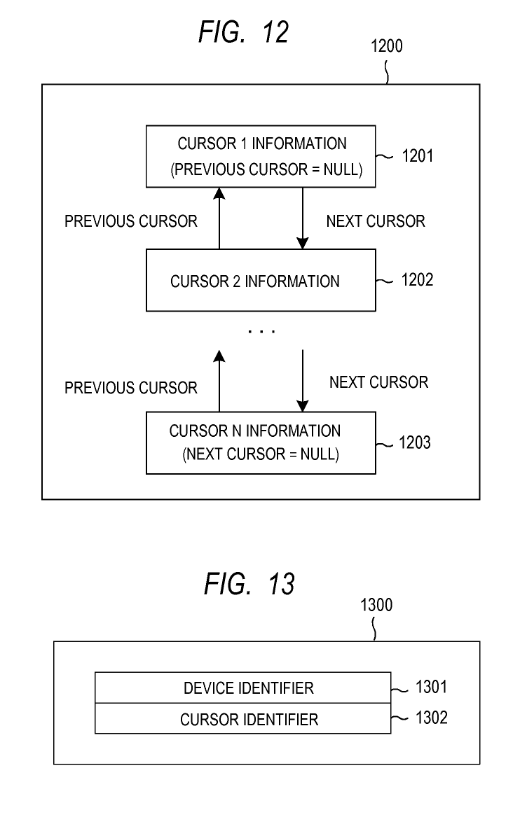

FIG. 12 is a diagram illustrating an example of a cursor list of the generated cursors to be managed by the resource managing unit 106.

The whole of a cursor list 1200 includes information 1201 indicating a cursor 1 which is first generated by the application 101, and cursor information 1202 and 1203 indicating cursors which are generated by the application 101. More specifically, the information 1202 indicates a cursor 2, and the information 1203 indicates a cursor N. In the cursor list, the cursors generated from the application 101 are simply link-listed in order.

FIG. 13 is a diagram illustrating an example of a cursor-device association request for the association by the application 101.

The whole of a cursor-device association request 1300 includes a device identifier 1301 of the device to be associated, and a cursor identifier 1302 of the cursor to be associated. Incidentally, each of the device identifier 1301 and the cursor identifier 1302 is the area which is used to transfer the set value of the association from the application 101 to the cursor-device associating unit 103.

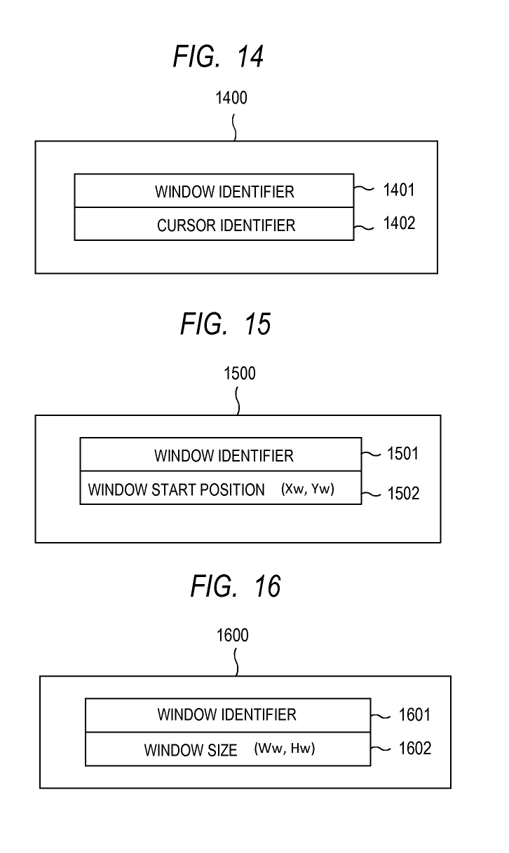

FIG. 14 is a diagram illustrating an example of a cursor-window association request for the association by the application 101.

The whole of a cursor-window association request 1400 includes a window identifier 1401 of the window to be associated, and a cursor identifier 1402 of the cursor to be associated. Incidentally, each of the window identifier 1401 and the cursor identifier 1402 is the area which is used to transfer the set value of the association from the application 101 to the cursor-window associating unit 104. The cursor-window associating unit 104 notifies the association managing unit 105 of the association information to be updated.

The association managing unit 105 updates the association window identifier 1111 of the relevant cursor management information 1100 from the resource managing unit 106 to the designated window identifier. If the association device identifier 1112 of the relevant cursor management information 1100 has been registered, the association cursor identifier 706 of the relevant device management information 700 is updated to the identifier of the association window identifier 1111 of the cursor management information 1100.

FIG. 15 is a diagram illustrating an example of a window position change request of the window generated by the application 101.

The whole of a window position change request 1500 includes a window identifier 1501 of the window to be changed, and a window start position 1502 indicating the start position of the changed window. The window start position 1502 is designated in the form of (X coordinate, Y coordinate). Each of the window identifier 1501 and the window start position 1502 is the area which is used to transfer the set value from the application 101 to the resource managing unit 106.

FIG. 16 is a diagram illustrating an example of a window size change request of the window generated by the application 101.

The whole of a window size change request 1600 includes a window identifier 1601 of the window of which the size is to be changed, and a window size 1602 indicating the size of change. The window size 1602 is designated in the form of (width, height). Each of the window identifier 1601 and the window size 1602 is the area which is used to transfer the set value from the application 101 to the resource managing unit 106.

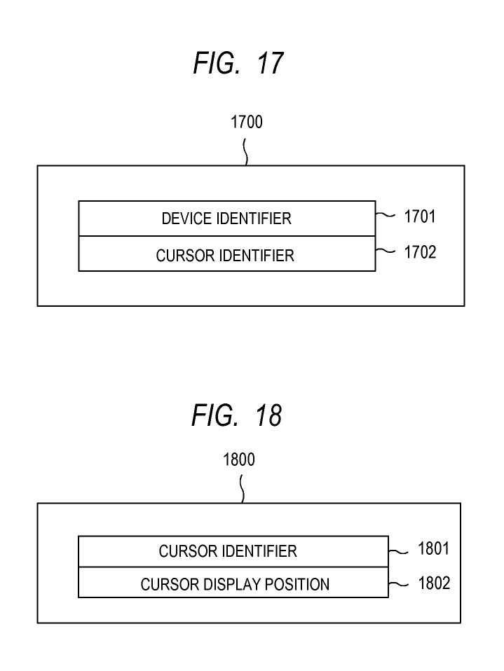

FIG. 17 is a diagram illustrating an example of a cursor identifier acquisition request of the cursor associated with the generated device, by the device driver 102.

The whole of a cursor identifier acquisition request 1700 associated with the device incudes a device identifier 1701 which is the area to be used to transfer the generated device identifier from the device driver 102 to the association managing unit 105, and a cursor identifier 1702 which is the area to be used to transfer the associated cursor identifier from the association managing unit 105 to the device driver 102.

FIG. 18 is a diagram illustrating an example of a cursor display position change request of the cursor associated with the generated device, by the device driver 102.

The whole of a cursor display position change request 1800 includes a cursor identifier 1801 of the cursor of which the display position is to be changed, and a cursor display position 1802 indicating the change display destination position. The cursor display position 1802 is designated in the form of (X coordinate, Y coordinate). Each of the cursor identifier 1801 and the cursor display position 1802 is the area which is used to transfer the set value from the device driver 102 to the cursor display controlling unit 110.

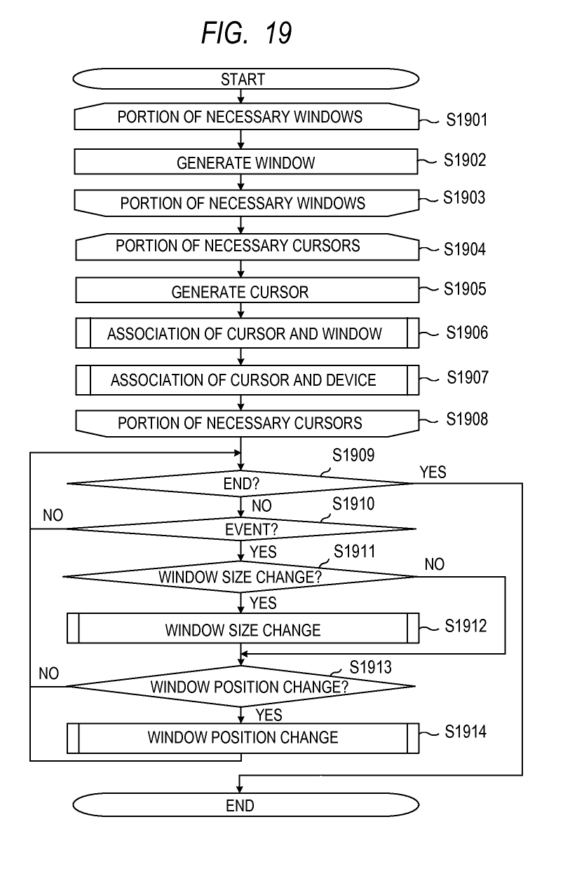

FIG. 19 is a flow chart for describing an example of the overall process to be performed by the application 101 in the window system according to the embodiment of the present invention. Hereinafter, the process will be described with reference to the relevant flow chart, also in consideration of FIGS. 1 to 5 and FIGS. 9 to 16.

The overall process is started from S1901, and the following processes are performed in the necessary window by the application 101.

In S1902, by the window generation request 200 of FIG. 2, the resource managing unit 106 generates the window. The resource managing unit 106 generates the window management information 400 after generating the window, and registers the information of the window generation request. Further, the resource managing unit registers the window identifier 403 to the window identifier 201, and notifies the application 101 of such registration.

The window start position 202 is registered to the window start position 404, and the window size 203 is registered to the window size 405. After the information was generated, the Z order of the window group is reconstituted. Here, “1” is added to the Z order in order of generation, and the acquired Z order is registered to the window Z order 406. The pointer to the window management information of which the Z order is previous by “1” to the generated window is registered to the pointer 402 to the previous window information of the window management information 400.

If the Z order is “1”, then the pointer to the root window information is registered. In the window management information 400 registered to the pointer 402 to the previous window information, the pointer to the window management information generated this time is registered to the pointer 401 to the next window information. Here, the root window is the special window which is generated when the window system is initialized. After the device generation, the process is advanced to S1903.

In S1903, it is checked whether or not all the necessary windows are generated. If it is checked that all the necessary windows are not generated yet, the process is returned to S1901. On the other hand, if it is checked that all the necessary windows are generated, the process is advanced to S1904. In the latter case, the generated windows are managed based on the window list 500 of FIG. 5 by the resource managing unit 106.

From S1904, the application 101 performs the following processes for the necessary cursor.

In S1905, by the cursor generation request 900 of FIG. 9, the resource managing unit 106 generates the cursor. After the cursor generation, the resource managing unit 106 generates the cursor management information 1100, and registers the information of the cursor generation request. Further, the cursor identifier 1103 is registered to the cursor identifier 901, and such registration is notified to the application 101.

The cursor start position 902 is registered to the cursor start position 1105, and the cursor movement range 903 is registered to the cursor movement range 1106. Likewise, the cursor image format 904, the cursor image size 905, and the pointer 906 to the cursor image are respectively registered to the cursor image format 1107, the cursor image size 1108, and the pointer 1109 to the cursor image.

Further, the pointer to the cursor management information generated previously by one is registered to the pointer 1102 to the cursor information previous to the cursor management information 1100. In case of first generation, “NULL” is registered. In a case where there is the cursor generated previously by one, the pointer to the cursor management information generated this time is registered to the pointer 1101 to the device information next to the one-previous cursor management information 1100. The display of the generated cursor is illustrated in FIG. 10. After the cursor generation, the process is advanced to S1906.

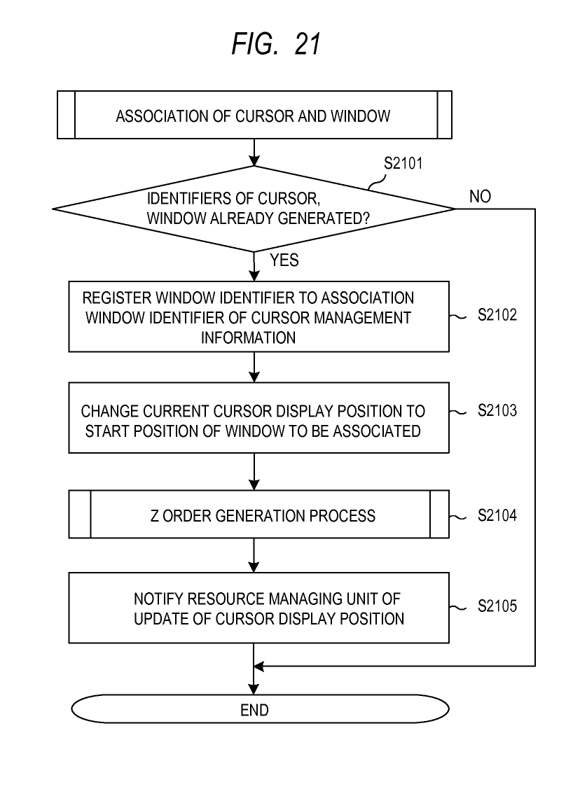

In S1906, the cursor and the window are associated with each other using the cursor-window association request 1400 of FIG. 14. The detailed process to be performed in S1906 will be described with reference to a flow chart of FIG. 21 which describes an example of the process of associating the cursor and the window with each other. Here, only one window can be associated with one cursor. Meanwhile, a plurality of cursors can be associated with one window. After the association in S1906, the process is advanced to S1907.

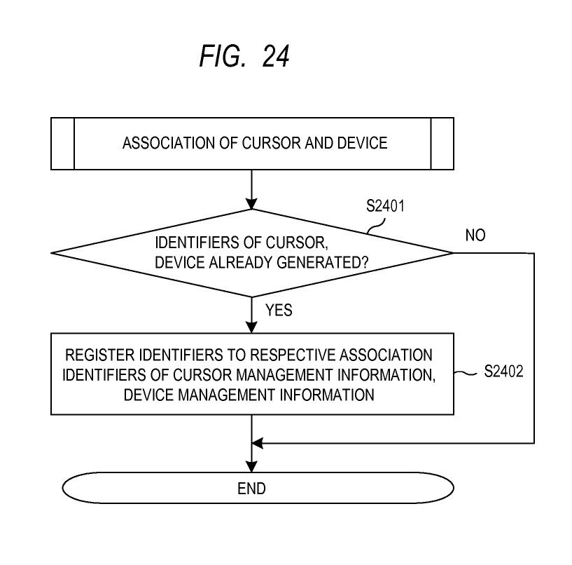

In S1907, the cursor and the device are associated with each other using the cursor-device association request 1300 of FIG. 13. The detailed process to be performed in S1907 will be described with reference to a flow chart of FIG. 24 which describes an example of the process of associating the cursor and the device with each other. Here, only one device can be associated with one cursor, and only one cursor can be associated with one device. After the association in S1907, the process is advanced to S1908.

In S1908, it is checked whether or not all the necessary cursors are generated. If it is checked that all the necessary cursors are not generated yet, the process is returned to S1904. On the other hand, if it is checked that all the necessary cursors are generated, the process is advanced to S1909. In the latter case, the generated cursors are managed based on the cursor list 1200 of FIG. 12 by the resource managing unit 106.

In S1909, it is checked whether or not to end the process of the application. If it is checked to end, the process in the application 101 is ended. On the other hand, if it is checked not to end, the process is advanced to S1910.

In S1910, the application checks whether or not an event occurs in the managed window or the managed cursor. If the event does not occur, the process is returned to S1909. On the other hand, if the event occurs, the process is advanced to S1911.

In S1911, it is judged whether or not to change the window size in the window in which the event occurs. If it is judged not to change the window size, the process is advanced to S1913. On the other hand, if it is judged to change the window size, the process is advanced to S1912.

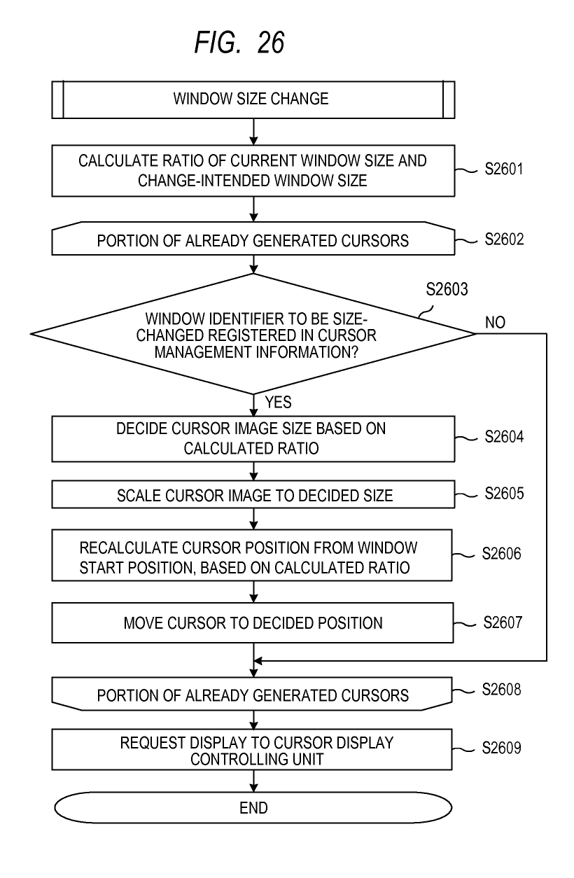

In S1912, the window size is changed and the cursor size linked thereto is changed using the window size change request 1600 of FIG. 16. The detailed process in S1912 will be described with reference to a flow chart of FIG. 26 which describes an example of the process of changing the cursor size and the display position according to the change of the window size. After the change, the process is advanced to S1913.

In S1913, it is judged, in the window in which the event occurs, whether or not to change the window position. If it is judged not to change the window position, the process is returned to S1909. On the other hand, if it is judged to change the window position, the process is advanced to S1914.

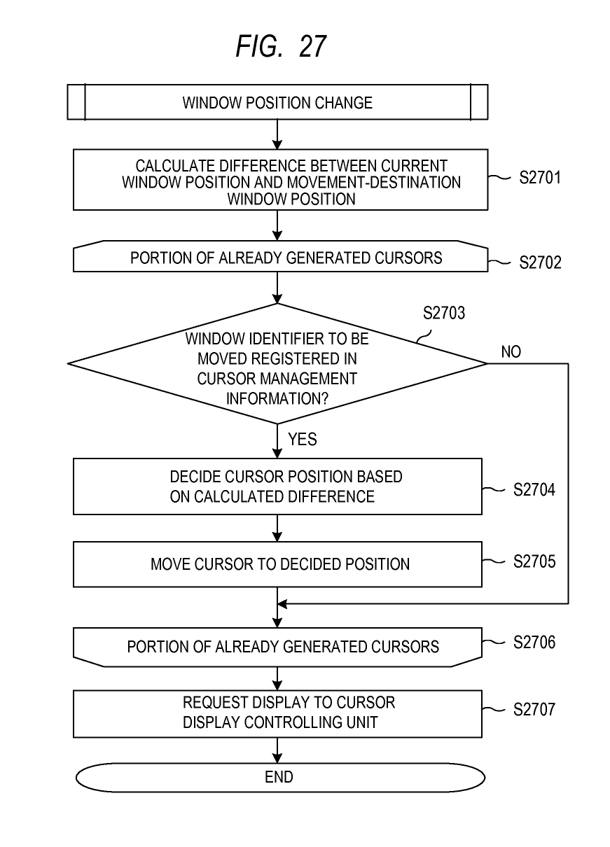

In S1914, the window position is changed and the cursor display position linked thereto is changed using the window position change request 1500 of FIG. 15. The detailed process in S1914 will be described with reference to a flow chart of FIG. 27 which describes an example of the process of changing the window position. After the change, the process is returned to S1909.

By associating the window and the cursor with each other with the application 101 according to the above process, it is possible to perform the associated cursor display control due to the changes of the window size and the window position.

Besides, by associating the device and the cursor with each other, it is possible to perform the cursor display control by the device driver 102. Thus, it is possible to easily perform the cursor display control which is linked to the change of the window.

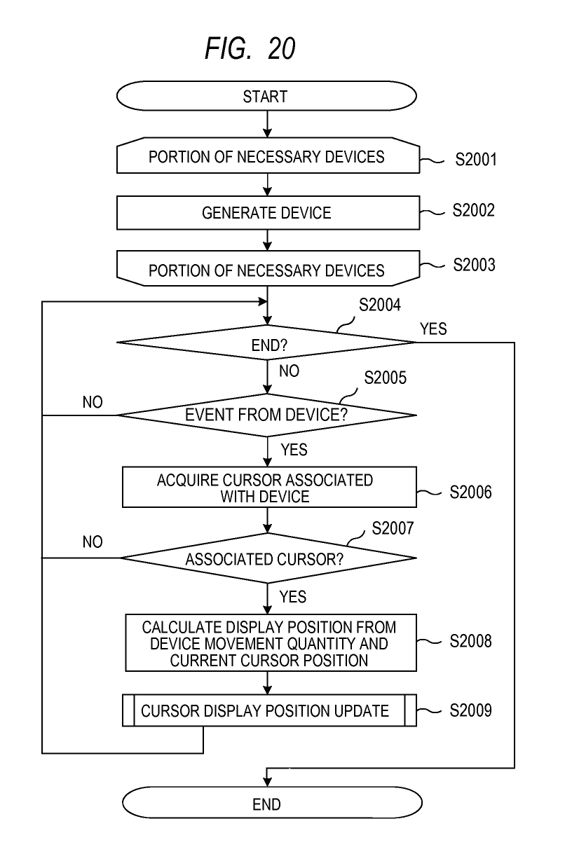

FIG. 20 is a flow chart for describing an example of the overall process to be performed by the device driver 102 in the window system according to the embodiment of the present invention. Hereinafter, the process will be described with reference to the relevant flow chart, also in consideration of FIGS. 1, 6, 7, 8 and 17.

The overall process is started from S2001, and the following processes are performed in the necessary device by the device driver 102.

In S2002, by the device generation request 600 of FIG. 6, the resource managing unit 106 generates the device. The resource managing unit 106 generates the device management information 700 after generating the device, and registers the information of the device generation request. Here, the device identifier 703 is registered to the device identifier 601, and such registration is notified to the device driver 102.

The device type 602 is registered to the device type 704, and the device name 603 is registered to the device name 705. Further, the pointer to the device management information generated previously by one is registered to the pointer 702 to the device information previous to the device management information 700. In case of first generation, “NULL” is registered. In a case where there is the device generated previously by one, the pointer to the device management information generated this time is registered to the pointer 701 to the device information next to the one-previous device management information 700. After the device generation, the process is advanced to S2003.

In S2003, it is checked whether or not all the necessary cursors are generated. If it is checked that all the necessary cursors are not generated yet, the process is returned to S2001. On the other hand, if it is checked that all the necessary cursors are generated, the process is advanced to S2004. In the latter case, the generated devices are managed based on the device list 800 of FIG. 8 by the resource managing unit 106.

In S2004, it is checked whether or not to end the process of the device driver. If it is checked to end the process, the process in the device driver 102 is ended. On the other hand, if it is checked not to end the process, the process is advanced to S2005.

In S2005, the device driver checks whether or not an event occurs from the managed device by a mouse operation or the like. If the event does not occur, the process is returned to S2004. On the other hand, if the event occurs, the process is advanced to S2006.

In S2006, in the device in which the event occurs, the cursor identifier 1702 is acquired by the cursor identifier acquisition request 1700 associated with the device in FIG. 17. After the acquisition, the process is advanced to S2007.

In S2007, it is checked, based on the fact that the acquired cursor identifier 1702 is valid, whether or not the associated cursor exists. If it is checked that the associated cursor does not exist, the process is returned to S2004. On the other hand, if it is checked that the associated cursor exists, the process is advanced to S2008.

In S2008, a new cursor display position is calculated from the device movement quantity due to the event occurrence and the current cursor display position acquired from the resource managing unit 106. After the calculation, the process is advanced to S2009.

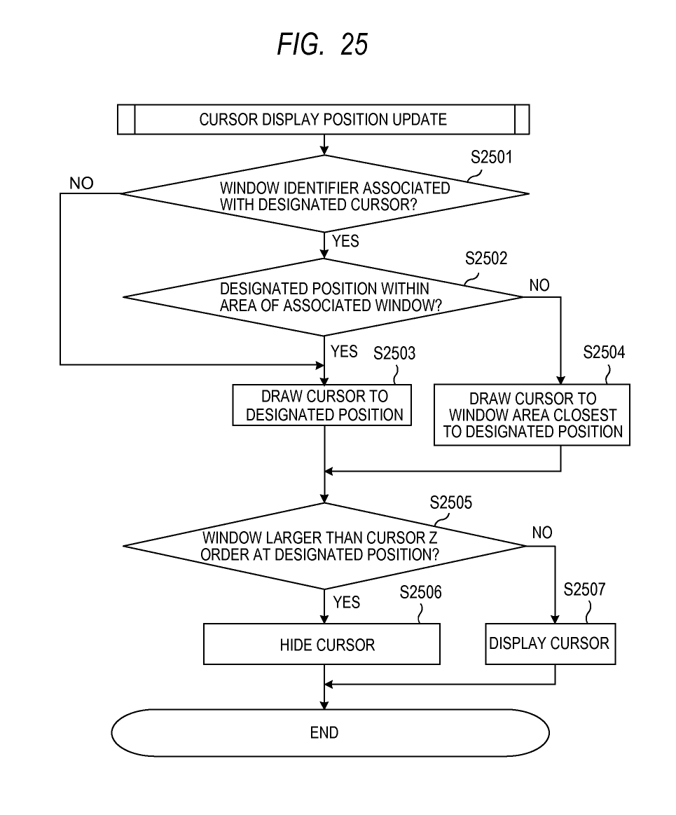

In S2009, the cursor display position is updated using the cursor display position change request 1800 of FIG. 18. The detailed process to be performed in S2009 will be described with reference to a flow chart of FIG. 25 which describes an example of the cursor display position updating process. After the update in S2009, the process is returned to S2004.

By the above process, it is possible to update the cursor display position in the device event by the device driver 102. Thus, it is possible to easily perform the cursor display in the window associated with the cursor, by operating the display position to the cursor associated with the device.

Incidentally, the process in the application 101 of FIG. 19 and the process in the device driver 102 of FIG. 20 are performed in parallel.

FIG. 21 is a flow chart for describing an example of the process of associating the cursor and the window with each other in the window system according to the embodiment of the present invention. The process is performed by the cursor-window associating unit 104 and the cursor display area changing unit 109 in S1906 of the flow chart FIG. 19 which describes the overall process of the application 101. Hereinafter, the process will be described with reference to the relevant flow chart, also in consideration of FIGS. 1, 4, 11 and 14.

In S2101, by the cursor-window association request 1400 of FIG. 14, it is judged whether or not the window management information 400 of FIG. 4 and the cursor management information 1100 of FIG. 11 respectively corresponding to the window identifier 1401 and the cursor identifier 1402 are acquired from the resource managing unit 106. If any one of the window management information and the cursor management information cannot be acquired, then it is judged that the identifier is not yet generated, and the associating process is ended. If both the window management information and the cursor management information can be acquired, then it is judged that the identifiers have been generated, and the process is advanced to S2102.

In S2102, the window identifier is registered to the association window identifier 1111 of the acquired cursor management information 1100. After the registration, the process is advanced to S2103. The process up to this corresponds to the process to be performed by the cursor-window associating unit 104.

In S2103, the cursor display position 1104 of the cursor management information 1100 is changed to the window start position 404 of the window management information 400 of the associated window. For example, in a case where the cursor display position is given by the X coordinate 120 and the Y coordinate 100, if the coordinates of the start position of the window to be associated are the X coordinate 100 and the Y coordinate 60, the coordinates of the cursor display position are updated to the X coordinate 100 and the Y coordinate 60. After the update, the cursor movement range is changed to have the size of the associated window, and the process is advanced to S2104. This is the process to be performed by the cursor display area changing unit 109.

In S2104, the cursor Z order changing unit 108 generates the Z order value of the associated cursor from the window Z order. The detailed process in S2104 will be described with reference to a flow chart of FIG. 23 which describes an example of the process of generating the Z order value of the cursor. After the change, the process is advanced to S2105. In S2105, the cursor display controlling unit 110 notifies, to the resource managing unit 106, the fact that the cursor display position has been updated by the association. After the notification, the process of associating the cursor and the window with each other is ended.

By the above process, it is possible to associate the window and the cursor with each other. Thus, since it is possible to easily specify the cursor associated with the window and the window associated with the cursor, it is possible to update the cursor information and perform the display control in linkage with the change of the window information.

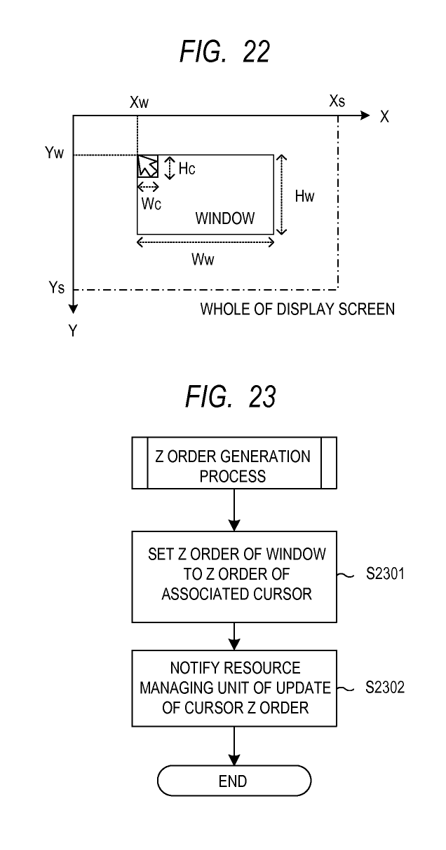

FIG. 22 is a diagram illustrating, on the whole of the display screen, the area of the window and the position of the cursor which have been associated with each other in the process of FIG. 21 with the application 101, by the cursor-window association request 1400 of FIG. 14. Since the cursor display position associated with the window start position is set by the cursor-window association request 1400 from the application 101, the cursor is displayed at the position (Xw, Yw).

In the association of the window size and the cursor size, the current cursor size in the window size at the time of the association is used as the basic value. Therefore, the cursor size (Wc, Hc) in the window size (Ww, Hw) is the basic association.

FIG. 23 is the flow chart for describing an example of the process of generating the Z order value of the associated cursor from the window management information of the window system according to the embodiment of the present invention. The process corresponds to the process in the cursor Z order changing unit 108 to be performed in S2104 of the flow chart of FIG. 21 for describing the process of associating the cursor and the window with each other. Hereinafter, the process will be described with reference to the relevant flow chart, also in consideration of FIGS. 1, 4, 11 and 14.

In S2301, by the cursor-window association request 1400 of FIG. 14, the window management information 400 of FIG. 4 and the cursor management information 1100 of FIG. 11 respectively corresponding to the window identifier 1401 and the cursor identifier 1402 are acquired from the resource managing unit 106. The value of the window Z order 406 of the acquired window management information 400 is set to the cursor Z order 1110 of the cursor management information 1100. After the setting, the process is advanced to S2302.

In S2302, the fact that the cursor Z order is updated by the association is notified to the resource managing unit 106. After the notification, the cursor Z order generating process is ended.

By the above process, it is possible to set the Z order of the associated window as the Z order of the cursor. Thus, in the cursor associated with the window, it is possible to judge the display control by the Z order.

FIG. 24 is the flow chart for describing an example of the process of associating the cursor and the device with each other in the window system according to the embodiment of the present invention. The process corresponds to the process in the cursor-device associating unit 103 to be performed in S1907 of the overall process flow by the application 101 in FIG. 19. Hereinafter, the process will be described with reference to the relevant flow chart, also in consideration of FIGS. 1, 7, 11 and 13.

In S2401, by the cursor-device association request 1300 of FIG. 13, the device management information 700 of FIG. 7 and the cursor management information 1100 of FIG. 11 respectively corresponding to the device identifier 1301 and the cursor identifier 1302 are acquired from the resource managing unit 106. If any one of the device management information and the cursor management information cannot be acquired, it is judged that the identifier is not yet generated, and the associating process is ended. If both the device management information and the cursor management information can be acquired, then it is judged that the identifiers have been generated, and the process is advanced to S2402.

In S2402, the cursor identifier is registered to the association cursor identifier 706 of the acquired device management information 700. Further, the device identifier is registered to the association device identifier 1112 of the acquired cursor management information 1100.

By the above process, it is possible to associate the device and the cursor with each other. Thus, it is possible to easily specify the cursor associated with the device and the device associated with the cursor.

FIG. 25 is the flow chart for describing an example of the process of updating the cursor display position by the event of the device in the window system according to the present embodiment. The process corresponds to the process in the cursor display controlling unit 110 to be performed in S2009 of the overall process flow by the device driver 102 of FIG. 20. Hereinafter, the process will be described with reference to the relevant flow chart, also in consideration of FIGS. 1, 4, 11 and 18.

In S2501, by the cursor display position change request 1800 of FIG. 18, the cursor management information 1100 of FIG. 11 corresponding to the cursor identifier 1801 is acquired from the resource managing unit 106. Then, it is checked whether or not the window identifier is registered in the association window identifier 1111 of the acquired cursor management information 1100. If the window identifier is not registered, the process is advanced to S2503. On the other hand, if the window identifier is registered, the relevant window management information 400 is acquired, and the process is advanced to S2502.

In S2502, it is checked whether or not the position at the cursor display position 1802 of the cursor display position change request 1800 is within the area of the window associated with the cursor. Here, the area of the window is calculated from the window start position 404 and the window size 405 of the window management information 400. If it is checked that the cursor display position 1802 is outside the window area, the process is advanced to S2504. On the other hand, if it is checked that the cursor display position is within the window area, the process is advanced to S2503.

In S2503, the current cursor position is drawn to the position designated by the cursor display position 1802. After the drawing, the process is advanced to S2505.

In S2504, the value of the window area which is closest respectively to the X coordinate and the Y coordinate of the cursor display position 1802, and the cursor is drawn using the calculated position as the cursor display position. After the drawing, the process is advanced to S2505.

In S2505, it is checked whether or not, at the cursor display position decided in S2503 or S2504, there is the window of which the Z order is larger than the Z order of the drawn cursor. If the cursor is associated with the window in the process of FIG. 23, the Z order of the cursor is set to the Z order value of the associated window. On the other hand, if the cursor is not associated with the window, the Z order of the cursor is set to the default value “0”.

If the cursor is associated with the window and there is the window of which the Z order is larger than the Z order of the cursor, the process is advanced to S2506. On the other hand, if the cursor is associated with the window and there is no window of which the Z order is larger than the Z order of the cursor, the process is advanced to S2507. Also, if the cursor is not associated (that is, if the Z order of the cursor is the default “0”), the process is advanced to S2507.

In S2506, the cursor is deleted by hiding (non-display) the current cursor display. After the hiding, the cursor display position updating process is ended.

In S2507, the current cursor is displayed. After the display, the cursor display position updating process is ended.

If the process is ended, as illustrated in FIG. 1, the cursor display update notification is transferred from the cursor display controlling unit 110 to the resource managing unit 106.

By the above process, since the window and the cursor are associated with each other, it is possible to easily display the cursor in the area of the associated window. Further, it is possible to easily perform the cursor display control in linkage with the Z order of the associated window.

FIG. 26 is the flow chart for describing an example of the process of changing the cursor size and the display position, according to a change of the window size in the window system according to the embodiment of the present invention. The process corresponds to the process in the cursor scaling unit 107 to be performed in S1912 of the overall process flow by the application 101 of FIG. 19. Hereinafter, the process will be described with reference to the relevant flow chart, also in consideration of FIGS. 1, 4, 11 and 16.

In S2601, by the window size change request 1600 of FIG. 16, the window management information 400 of FIG. 4 corresponding to the window identifier 1601 is acquired from the resource managing unit 106. Then, the window size 405 of the acquired window management information 400 and the window size 1602 of the window size change request 1600 are compared with each other to calculate a ratio (difference) of the relevant two sizes. For example, if the window having the width 1600 and the height 1200 is size-changed to the window having the width 800 and the height 600, the ratio of the widths and the ratio of the heights are both 0.50.

In S2602 and the subsequent steps, the following processes are performed to all the generated cursors.

In S2603, it is checked whether or not the association window identifier 1111 of the cursor management information 1100 is the same as the window identifier 1601 (that is, it is checked whether or not the association window identifier to be size-changed has been registered in the cursor management information). If it is checked that these identifiers are different from each other, the process is advanced to S2608. On the other hand, if it is checked that these identifiers are the same, the process is advanced to S2604.

In S2604, the size of the cursor image size 1108 of the cursor management information 1100 is decided based on the ratio calculated in S2601. For example, if the cursor size is given by the width 32 and the height 32, each of the width and the height is decided to 16. If the size is decided, the value of the cursor image size 1108 is updated, and the process is advanced to S2605.

In S2605, the cursor image is scaled to the updated size. After the scaling, the process is advanced to S2606.

In S2606, the cursor display position 1104 of the cursor management information 1100 is recalculated and decided based on the ratio calculated in S2601. Here, the distance between the cursor start position to the current cursor display position is changed based on the ratio. For example, if the window start position is given by the X coordinate 100 and the Y coordinate 60 and the cursor display position is given by the X coordinate 140 and the Y coordinate 80, the distance between the window start position and the cursor display position is given by the X coordinate 40 and the Y coordinate 20.

In the difference of the distance, the X coordinate 20 and the Y coordinate 10 are obtained by multiplying the X coordinate by the ratio of the width 0.50 and multiplying the Y coordinate by the ratio of the height 0.50. As a result, the cursor display position is given by the X coordinate 120 and the Y coordinate 70. If the display position is decided, the process is advanced to S2607.

In S2607, the value of the cursor display position 1104 is updated, and the process is advanced to S2608.

In S2608, it is checked whether or not all the generated cursors have been processed. If it is checked that all the cursors are not yet processed, the process is returned to S2602. On the other hand, if it is checked that all the cursors have been processed, the process is advanced to S2609.

In S2609, the display request is transferred to the cursor display controlling unit 110 so as to draw the scaled cursor image to the changed display position in the size-changed window. After the drawing, the cursor size changing process by the window size change is ended.

By the above process, since the window and the cursor are associated with each other, it is possible to easily scale the cursor size in linkage with the change of the window size and to easily change and display the cursor display position. Further, it is possible to associate a plurality of cursors with one window. In this case, it is possible to scale all the cursor sizes associated with the window. Furthermore, it is possible to change and display all the cursor display positions associated with the window.

FIG. 27 is the flow chart for describing an example of the process of changing the cursor display position according to a change of the window position in the window system according to the embodiment of the present invention. The process corresponds to the process in the cursor display area changing unit 109 to be performed in S1914 of the overall process flow by the application 101 of FIG. 19. Hereinafter, the process will be described with reference to the relevant flow chart, also in consideration of FIGS. 1, 4, 11 and 15.

In S2701, by the window position change request 1500 of FIG. 15, the window management information 400 of FIG. 4 corresponding to the window identifier 1501 is acquired from the resource managing unit 106. Then, the window start position 404 of the acquired window management information 400 and the window start position 1502 of the window position change request 1500 are compared with each other to calculate the difference between the relevant two positions. For example, if the window at the start position of the X coordinate 100 and the Y coordinate 60 is changed to the position of the X coordinate 50 and the Y coordinate 80, the difference in the X coordinate is 50 and the difference in the Y coordinate is 20.

In S2702 and the subsequent steps, the following processes are performed to all the generated cursors.

In S2703, it is checked whether or not the association window identifier 1111 of the cursor management information 1100 is the same as the window identifier 1501 (that is, whether or not the association window identifier to be moved has been registered in the cursor management information). If it is checked that these identifiers are different from each other, the process is advanced to S2706. On the other hand, if it is checked that these identifiers are the same, the process is advanced to S2704.

In S2704, the cursor display position 1104 of the cursor management information 1100 is decided based on the difference calculated in S2701. For example, if the coordinates of the cursor display position are the X coordinate 140 and the Y coordinate 80, the X coordinate is changed to 90 and the Y coordinate is changed to 100. If the display position is decided, the process is advanced to S2705.

In S2705, the value of the cursor display position 1104 is updated, the size of the cursor movement range is changed to the size of the associated window, and the process is advanced to S2706.

In S2706, it is checked whether or not the process to all the generated cursors is completed. If it is checked that all the generated cursors are not yet processed completely, the process is returned to S2702. On the other hand, if it is checked that all the generated cursors have been processed, the process is advanced to S2707.

In S2707, the cursor image of which the display position has been changed is drawn in the window of which the position has been changed. After the drawing, the cursor display position changing process based on the window position is ended.

By the above process, since the window and the cursor are associated with each other, it is possible to easily change and display the cursor display position in linkage with the change of the window start position. Further, it is possible to associate a plurality of cursors with one window. In this case, it is possible to change and display all the cursor display positions associated with the window.

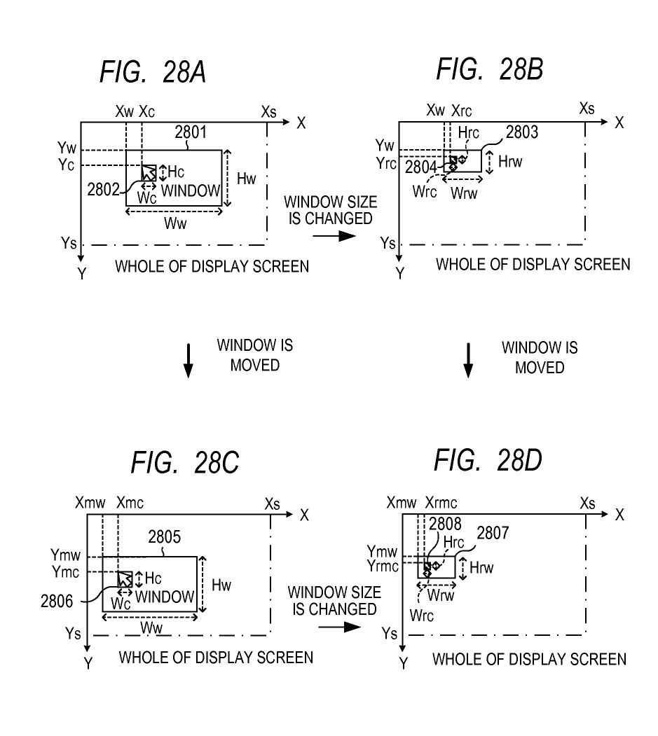

FIGS. 28A to 28D are diagrams illustrating the areas of the windows and the cursors on the whole of the display screen according to changes of the window positions and changes of the window sizes in the window system according to the embodiment of the present invention.

FIG. 28A illustrates the display state in which both the window position and the window size are not changed. More specifically, a cursor 2802 is displayed in a window 2801. The start position of the window 2801 is (Xw, Yw), and the size thereof is (Ww, Hw). In this example, Xw=100, Yw=60, the width Ww=1600, and the height Hw=1200 are given. The display position of the cursor 2802 is (Xc, Yc), and the size thereof is (Wc, Hc). In this example, Xc=140, Yc=80, the width Wc=32, and the height Hc=32 are given.

FIG. 28B illustrates the display state in which the window size is changed from the state of FIG. 28A. More specifically, a cursor 2804 is displayed in a window 2803. The start position of the window 2803 is (Xw, Yw), and the size thereof is (Wrw, Hrw). In this example, the start position is not changed because Xw=100 and Yw=60. The window size is given by the width Wrw=800 and the height Hrw=600. The display position of the cursor 2804 is (Xrc, Yrc), and the size thereof is (Wrc, Hrc). In this example, Xrc=120, Yrc=70, the width Wrc=16, and the height Hrc=16 are given.

FIG. 28C illustrates the display state in which the window position is changed from the state of FIG. 28A. More specifically, a cursor 2806 is displayed in a window 2805. The start position of the window 2805 is (Xmw, Ymw), and the size thereof is (Ww, Hw). In this example, Xmw=50, Ymw=80, the width Ww=1600 and the height Hw=1200 are given, and the size is not changed. The display position of the cursor 2806 is (Xmc, Ymc), and the size thereof is (Wc, Hc). In this example, Xmc=90, Ymc=100, the width Wc=32, and the height Hc=32 are given.

FIG. 28D illustrates the display state in which the window position is changed from the state of FIG. 28B, and also illustrates the display state in which the window size is changed from the state of FIG. 28C. More specifically, a cursor 2808 is displayed in a window 2807. The start position of the window 2807 is (Xmw, Ymw), and the size thereof is (Wrw, Hrw). In this example, Xmw=50 and Ymw=80 are given, and the size is given by the width Wrw=800 and the height Hrw=600. The display position of the cursor 2808 is (Xrmc, Yrmc), and the size thereof is (Wrc, Hrc). In this example, Xrmc=70, Yrmc=90, the width Wrc=16, and the height Hrc=16 are given. From this result, it can be understood that the size change and the position change of the window are not related particularly to the order, and the display result by the combination of the two changes come to be the same.

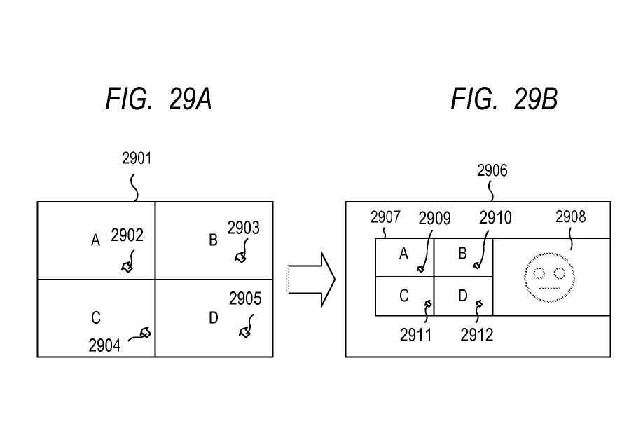

In the above description, the one cursor is associated with the one window. However, it is possible to associate a plurality of cursors with one window. Such a case will be illustrated in FIGS. 29A and 29B.

FIGS. 29A and 29B are the diagrams illustrating the display screen state at the time of PC screen transfer in the window system according to the embodiment. Here, the PC screen transfer is the display style in which the screens of four computers (PCs) A, B, C and D are displayed on one projector screen.

FIG. 29A illustrates an example of the projector screen on which the PC screen transfer is displayed.

In FIG. 29A, the screens of the computers A, B, C and D are displayed in a window 2901. Further, cursors 2902, 2903, 2904 and 2905 are displayed. More specifically, the computer A has the cursor 2902, the computer B has the cursor 2903, the computer C has the cursor 2904, and the computer D has the cursor 2905.

Therefore, the cursor 2902 is associated with the mouse device of the computer A, the cursor 2903 is associated with the mouse device of the computer B, the cursor 2904 is associated with the mouse device of the computer C, and the cursor 2905 is associated with the mouse device of the computer D. In addition, the relevant four cursors are associated with the window 2901.

FIG. 29B illustrates the display screen state at the time when the two screens (i.e., the screen of the PC screen transfer and the screen of the moving image) are displayed.

The whole of a display screen 2906 includes a screen 2907 corresponding to the PC screen transfer window 2901 of FIG. 29A. Since the two screens are displayed on the display screen, each window size is reduced and each window start position is changed.

Further, the display screen includes a moving image window 2908 for which any cursor is not used. Furthermore, the display screen includes cursors 2909, 2910, 2911 and 2912 of which the sizes and the display positions are changed due to the two-screen display. More specifically, the cursor 2909 corresponds to the cursor 2902 of FIG. 29A, the cursor 2910 corresponds to the cursor 2903 of FIG. 29A, the cursor 2911 corresponds to the cursor 2904 of FIG. 29A, and the cursor 2912 corresponds to the cursor 2905 of FIG. 29A.

The window size of the window 2901 is first changed. Then, the cursor image sizes and the cursor display positions of the associated four cursors are changed according to the ratio of the window size change. After then, the respective cursor display positions of the associated four cursors are changed based on the differences of the window positions according to the position change of the window 2901.

Finally, the changed cursors 2909, 2910, 2911 and 2912 are displayed in the changed window 2907, and the display screen illustrated in FIG. 29B is given. Further, it is possible, by operating the respective mice of the computers A, B, C and D, to perform the display control to the associated cursors 2909, 2910, 2911 and 2912.

As above, in the window system according to the present embodiment, it is possible, by associating the window and the cursor with each other, to perform the cursor display control in linkage with the window change. Moreover, it is possible, by associating the device and the cursor with each other, to perform the cursor display control in linkage with the device operation. Therefore, the visibility of the cursor is improved by the linkage of the cursor display in the window and device operations by the user.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-010802, filed Jan. 23, 2014, which is hereby incorporated by reference herein in its entirety.

What is claimed is:

1. A display controlling apparatus which is connected to an input apparatus and a display apparatus, comprising:
an acquiring unit configured to acquire, from the input apparatus, image information of a first image displayed on a display screen of the input apparatus and cursor information indicating a display position of a first cursor image on the display screen of the input apparatus;
a deciding unit configured to decide a display position of a second cursor image in a display range within which the display apparatus displays an image, based on the cursor information acquired by the acquiring unit; and
a controlling unit configured to perform control to display a second image based on the acquired image information and the second cursor image on the display apparatus, and change, according to a change of a size of the second image to be displayed on the display apparatus, a size of the second cursor image to be displayed on the display apparatus.

2. The display controlling apparatus according to claim 1, wherein the first image is an image not including the first cursor image displayed on the display screen of the input apparatus.

3. The display controlling apparatus according to claim 1, further comprising a generating unit configured to generate the second cursor image according to the acquisition of the cursor information indicating the display position of the first cursor image, and generate the second image based on the image information acquired by the acquiring unit.

4. The display controlling apparatus according to claim 1, wherein
the display controlling apparatus is connected to a first input apparatus and a second input apparatus, and
the controlling unit performs control to the display apparatus to switch a state from a first state that a third image corresponding to image information input from the first input apparatus is displayed in the display range of the display apparatus to a second state that a fourth image corresponding to image information input from the second input apparatus is displayed in addition to the third image in the display range, and performs control to change the size of the second cursor image according to the switch from the first state to the second state.

5. A display controlling system in which information indicating a display position of a first cursor image on a display screen of an input apparatus and image information of a first window image displayed on the display screen are acquired from the input apparatus, and a second cursor image corresponding to the first cursor image and a second window image corresponding to the first window image are output to a display apparatus, the system comprising:
a managing unit configured to manage information concerning the plurality of second window images based on Z order of displaying the second window images, manage information concerning the plurality of second cursor images based on order of generation of the second cursor images, and manage device information concerning the input apparatus based on order of generation of the device information;
a first associating unit configured to associate the second cursor image and the second window image with each other based on the information managed by the managing unit;
a second associating unit configured to associate the second cursor image and the device information with each other based on the information managed by the managing unit;
a deciding unit configured to decide a display area of the second cursor image in a display range within which the display apparatus displays the second window image, according to a size change of the second window image; and
a display controlling unit configured to perform control to display the second cursor image on the display apparatus, based on the information associated by the first associating unit, the information associated by the second associating unit and the display area decided by the deciding unit.

6. The display controlling system according to claim 5, further comprising a changing unit configured to change, based on the association by the first associating unit, Z order of the second cursor image in an area in which the display apparatus displays the second window, according to a change of the Z order of the second window image.

7. The display controlling system according to claim 5, wherein the image information of the first window image includes information indicating at least one of a display position, a width and a height of the first window image on the display screen of a display unit of the input apparatus.

8. The display controlling system according to claim 5, wherein the information indicating the display position of the first cursor image includes information indicating at least one of a start position of movement of the first cursor image on the display screen of a display unit of the input apparatus, a movement range of the first cursor image on the display screen, and a size of the first cursor image.

9. The display controlling system according to claim 5, wherein the managing unit generates an identifier of the second window image and information indicating the Z order of the second window image, and manages the generated identifier in the form of a linked list based on the Z order of the second window image.

10. The display controlling system according to claim 5, wherein the managing unit manages at least one of the information concerning the second window image, the information concerning the second cursor image and the device information concerning the input apparatus in the form of a linked list.

11. The display controlling system according to claim 5, wherein
the managing unit notifies, in a case where the information to be managed is updated, the display controlling unit of the update, and
the display controlling unit performs control to display the second cursor image on the display apparatus, based on the notification.

12. The display controlling system according to claim 5, wherein
the first associating unit associates identification information of the second cursor image with identification information of the second window image to be displayed together with the second cursor image, and
the second associating unit associates the identification information of the second cursor image with identification information of the device information of the input apparatus which inputs the cursor information corresponding to the second cursor image.

13. The display controlling system according to claim 5, wherein
a change instruction for changing a size of the second window image to be displayed in the area within which the display apparatus displays the image is acquired from the input apparatus, and
the display controlling unit changes the size of the second window image to be displayed in the display range of the display apparatus, according to the acquisition of the change instruction.

14. The display controlling system according to claim 5, wherein
a change instruction for changing a position of the second window image to be displayed in the display area of the display apparatus is acquired from the input apparatus, and
the display controlling unit changes the position of the second window image to be displayed in the display range of the display apparatus, according to the acquisition of the change instruction.

15. The display controlling system according to claim 5, wherein
the deciding unit decides the display position of the second cursor image in the display range, according to a change of a display position of the second window image in the display range of the display apparatus, and
the display controlling unit performs the control to display the second cursor image on the display apparatus, based on the display position decided by the deciding unit.

16. The display controlling system according to claim 5, wherein
a change instruction for changing a position of the second cursor image to be displayed in the display range of the display apparatus is acquired from the input apparatus in a state being associated with identification information of the second cursor image, and
the display controlling unit changes a position of the second window image to be displayed in the display range of the display apparatus, according to the acquisition of the change instruction.

17. A controlling method to be performed by a display controlling apparatus connected to an input apparatus and a display apparatus, the method comprising:
an acquiring step of acquiring, from the input apparatus, image information of a first image displayed on a display screen of the input apparatus and cursor information indicating a display position of a first cursor image on the display screen of the input apparatus;
a deciding step of deciding a display position of a second cursor image in a display area in which the display apparatus displays an image, based on the cursor information acquired in the acquiring step; and
a controlling step of performing control to display a second image based on the acquired image information and the second cursor image on the display apparatus, and change, according to a change of a size of the second image to be displayed on the display apparatus, a size of the second cursor image to be displayed on the display apparatus.

18. A controlling method to be performed by a display controlling system in which information indicating a display position of a first cursor image and image information of a first window image on a display screen of an input apparatus are acquired from the input apparatus, and a second cursor image corresponding to the first cursor image and a second window image corresponding to the first window image are output to a display apparatus, the method comprising:
a managing step of managing information concerning the plurality of second window images generated according to a request from an application in Z order of the second window images, managing information concerning the plurality of second cursor images generated according to the request from the application based on order of generation of the second cursor images, and managing device information concerning the input apparatus based on order of generation of the device information;
a first associating step of associating the second cursor image and the second window image with each other according to the request from the application, based on the information managed in the managing step;
a second associating step of associating the second cursor image and the device information with each other according to the request from the application, based on the information managed in the managing step;
a deciding step of deciding a display area of the second cursor image in an area within which the display apparatus displays the second window image, in accordance with a size change of the second window image according to the request from the application; and
a display controlling step of performing control to display the second cursor image on the display apparatus, based on the information associated in the first associating step, the information associated in the second associating step and the display area decided in the deciding step.

19. A non-transitory computer-readable recording medium which records thereon a program to cause a computer connected to an input apparatus and a display apparatus, to execute:
an acquiring process of acquiring, from the input apparatus, image information of a first image displayed on a display screen of the input apparatus and cursor information indicating a display position of a first cursor image on the display screen of the input apparatus;
a deciding process of deciding a display position of a second cursor image in a display area in which the display apparatus displays an image, based on the cursor information acquired in the acquiring process; and
a controlling process of performing control to display a second image based on the acquired image information and the second cursor image on the display apparatus, and change, according to a change of a size of the second image to be displayed on the display apparatus, a size of the second cursor image to be displayed on the display apparatus.

20. A non-transitory computer-readable recording medium which records thereon a program to cause a computer which acquires information indicating a display position of a first cursor image and image information of a first window image on a display screen of an input apparatus from the input apparatus, and outputs a second cursor image corresponding to the first cursor image and a second window image corresponding to the first window image to a display apparatus, to execute:
a managing process of managing information concerning the plurality of second window images generated according to a request from an application in Z order of the second window images, managing information concerning the plurality of second cursor images generated according to the request from the application based on order of generation of the second cursor images, and managing device information concerning the input apparatus based on order of generation of the device information;
a first associating process of associating the second cursor image and the second window image with each other according to the request from the application, based on the information managed in the managing process;
a second associating process of associating the second cursor image and the device information with each other according to the request from the application, based on the information managed in the managing process;
a deciding process of deciding a display area of the second cursor image in an area within which the display apparatus displays the second window image, in accordance with a size change of the second window image according to the request from the application; and
a display controlling process of performing control to display the second cursor image on the display apparatus, based on the information associated in the first associating process, the information associated in the second associating process and the display area decided in the deciding process.
